(19) United States
(12) Patent Application Publication
(10) Pub. No.: US 2018/0318705 A1
(43) Pub. Date: Nov. 8, 2018

(54) Touch-Screen Based Game Controller

(71) Applicants: Claus Christopher Moberg, Redwood City, CA (US); Michael McHale, San Mateo, CA (US); Justin Helms, San Jose, CA (US)

(72) Inventors: Claus Christopher Moberg, Redwood City, CA (US); Michael McHale, San Mateo, CA (US); Justin Helms, San Jose, CA (US)

(73) Assignee: Roblox Corporation, San Mateo, CA (US)

(21) Appl. No.: 15/586,707

(22) Filed: May 4, 2017

(51) Int. Cl. A63F 13/2145; G06F 3/0488; G06F 3/0484; G06F 3/0481

(52) U.S. Cl. CPC A63F 13/2145; G06F 3/04815; G06F 3/04845; G06F 3/04883

(57) ABSTRACT

A game platform is based on a mobile device having a touch screen and software enabling connection to a network-connected game server; and a control script executing on a processor of the mobile device. In game play, the control script configures the touch screen into a first region accepting touch input controlling avatar movement, and a second region accepting touch input controlling camera position and direction, and, in play of a game, game progression is displayed on part or all of the touch screen.

### BACKGROUND OF THE INVENTION

### 1. Field of the Invention

The present invention is in the field of local or network-hosted three-dimensional (3D) game consumption, including 3D games and virtual environments, such as a virtual world, and pertains more particularly to methods and apparatus for controlling a game avatar via a touch screen on a mobile device.

### 2. Discussion of the State of the Art

In the art of 3D gaming, mobile players, meaning those that are accessing and playing 3D games available for mobile devices, is becoming a larger part of the market. In this context, a critical component for a player to enable successful navigation of and avatar control is the control scheme or method and apparatus built into the game for the mobile device user to manipulate. It is known to the inventors, but not necessarily known in the art, to have a single 3D game build that may enable play on a wide variety of different sorts of gaming devices, including on mobile phones and VR devices. For example, a game accessed from a mobile phone may present a specific control scheme for that player and device while the same game accessed through a computer may present a different control scheme for that player.

A challenge for a player using a mobile phone, such as a smart phone, is that it typically requires both hands to access and control the actions of the avatar in the game, let alone the camera position and direction in the game.

Therefore, what is clearly needed is a method and apparatus for controlling the movement of an avatar and associated camera in a 3D game accessed from a mobile device such as a smart phone or game device using just one hand.

### BRIEF SUMMARY OF THE INVENTION

In one embodiment of the [present invention a game platform is provided, comprising a mobile device having a touch screen, and software (SW) enabling connection to a network-connected game server, and a control script executing on a processor of the mobile device. In game play, the control script configures the touch screen into a first region accepting touch input controlling avatar movement, and a second region accepting touch input controlling camera position and direction, and, in play of a game, game progression is displayed on part or all of the touch screen.

In one embodiment a touch and drag in the first region causes the avatar to move in the environment of the game in the direction of the drag. Also in one embodiment rate of movement of the avatar during drag is controlled by distance of drag from original touch point. Also in one embodiment a tap on the touch screen causes the avatar to jump in the environment. And in one embodiment the tap on the touchscreen causes the avatar to jump onto or over a landscape element in the environment.

In one embodiment avatar position relative to landscape elements is used by the control script to determine avatar action relative to the landscape elements. Also in one embodiment a touch and drag in the second region causes camera direction to change in the display of the 3D environment on the touch screen. Also in one embodiment a drag vector up or down causes the camera to pan up or down, and a drag vector to left or right causes the camera to pan left or right. In one embodiment pinch-to-zoom, configured to control camera function, controls zoom in and zoom out for the camera. And in one embodiment the mobile device is a smart telephone.

In one embodiment of the invention, prior to connection to the network-connected game server, and streaming of a game to the mobile platform, control and touchscreen parameters of the mobile platform are determined, and a compatible control script is served to the mobile platform.

In another aspect of the invention a method is provided, comprising executing a control script on a processor of a mobile device having a touch screen, and software (SW) enabling connection to a network-connected game server, displaying a game on the touchscreen; and configuring the touch screen, by execution of the control script, into a first region accepting touch input controlling avatar movement in the game, and a second region accepting touch input controlling camera position and direction in the game.

In one embodiment of the method a touch and drag in the first region causes the avatar to move in the environment of the game in the direction of the drag. Also in one embodiment rate of movement of the avatar during drag is controlled by distance of drag from original touch point. Also in one embodiment a tap on the touch screen causes the avatar to jump in the environment. Also in one embodiment the tap on the touchscreen causes the avatar to jump onto or over a landscape element in the environment. Also in one embodiment avatar position relative to landscape elements is used by the control script to determine avatar action relative to the landscape elements.

In one embodiment a touch and drag in the second region causes camera direction to change in the display of the environment on the touch screen. Also in one embodiment a drag vector up or down causes the camera to pan up or down, and a drag vector to left or right causes the camera to pan left or right. Also in one embodiment pinch-to-zoom in the second region, configured to control camera function, controls zoom in and zoom out for the camera. In one embodiment the mobile device is a smart telephone. And in one embodiment, prior to connection to the network-connected game server, and streaming of a game to the mobile platform, control and touchscreen parameters of the mobile platform are determined, and a compatible control script is served to the mobile platform.

### BRIEF DESCRIPTION OF THE SEVERAL VIEWS OF THE DRAWINGS

FIG. 1 is an architectural overview of a communications network that supports online gaming and in-game Avatar control from a mobile device.

FIG. 2 is a front elevation view of a game displayed on a touch screen of a smart phone depicting a travel control of an in-game avatar.

FIG. 3 is a front elevation view of the smart phone of FIG. 2 depicting a control for navigating an avatar over an obstacle.

FIG. 4 is a front elevation view of the smart phone of FIG. 2 depicting a control, among other controls, for manipulating a camera associated with the avatar.

FIG. 5 is a sequence diagram depicting a sequence for identifying a smart phone requesting to play a game, and for providing avatar control logic to the requesting smart phone.

FIG. 6 is a process flow chart depicting steps for identifying a smart phone requesting to play a game, and providing appropriate avatar control logic to the requesting smart phone for the purpose of playing the game.

### DETAILED DESCRIPTION OF THE INVENTION

In various embodiments described in enabling detail herein, the inventors provide a unique avatar control scheme and methods for controlling functions, including navigation of an avatar in a three-dimensional game accessed from a smart phone having touch screen functionality, that reduces physical requirements for using both hands to simultaneously control an avatar in a game being played. The present invention is described in enabling detail using the following examples, which may describe more than one relevant embodiment falling within the scope of the present invention.

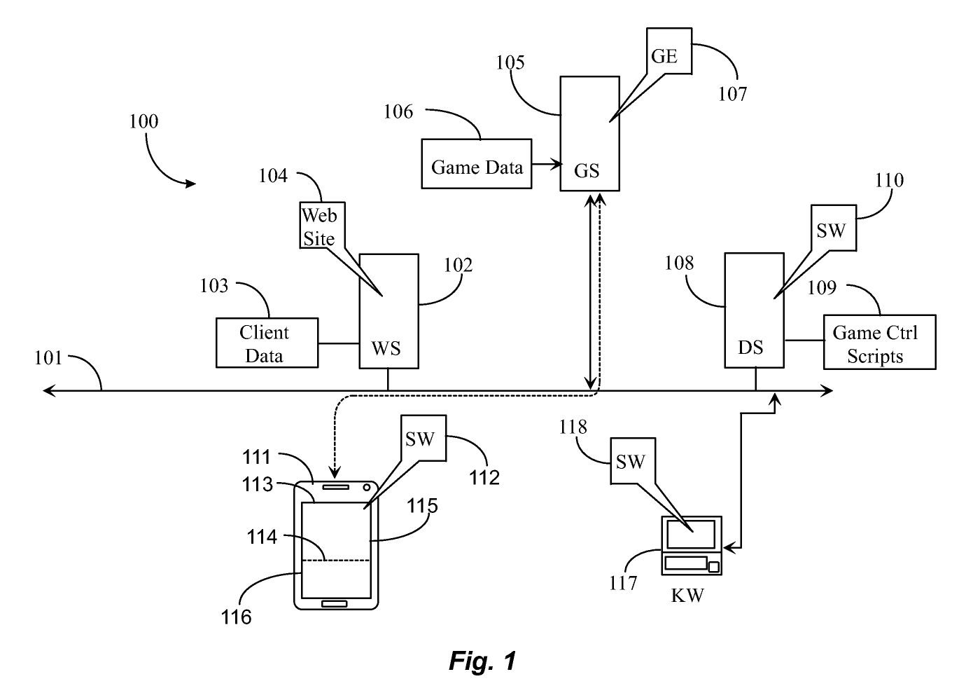

FIG. 1 is an architectural overview of a communications network 100 that supports online gaming and in-game Avatar control from a mobile device, according to an embodiment of the present invention. Communication network 100 includes the Internet network represented herein by a network backbone 101. Internet backbone 101 includes all of the lines equipment and access points that make up the Internet as a whole, including all connected sub-networks and carrier networks, both wired and wireless. Carrier networks and sub-networks are not specifically illustrated in this embodiment, but may be assumed present, such as would be in place for players to access the Internet.

Internet 101 supports a Web server 102 hosting a Website 104. Website 104 may be an access point for clients of an Internet gaming site that provides online 3D gaming for members. Web server 102 has connection to a data repository 103 containing client data, including profile, membership, billing, and other related data. In one embodiment, players that are site members of gaming Website 104 may log in and select games or environments from a searchable list of 3D games, that provides redirect links to one or more game servers hosting the games. One such server is a game server 105 hosting a game engine software (GE) 107. Game server 105 may be a cloud server that the gaming enterprise leases or otherwise maintains as an available server for playing 3D games. Game server 105 has connection to a data repository 106 that may contain game data and instruction for game data service.

It may be noted herein that a game provider may host games built by game developers, wherein the provider may not write game code for a game or modify any code that the developers have written relative to control schemes or platform/device support. Internet 101 supports a design server (DS) 108 running software (SW) 110. SW 110 enables a game provider to write specific avatar control schemes that may be supplemented for traditional avatar control schemes provided by the game developer. An avatar is the game element that represent a player or user and a control scheme may define a set of scripts created in code that may provide the input commands, and input mechanics used to trigger those commands. Such a control scheme may be created and may be provided for game players that may join a game from a mobile smart phone or similar device that includes a display with touch screen capability. It is desired that a player may have less complicated input mechanisms when operating from a smart mobile phone such as a smart phone 111 as is depicted herein.

Smart phone 111 is in a state of communication (game session) with game server 105 running game engine 107. Phone 111 may be operated as a hand-held wireless device that may access Internet backbone 101 through a wireless carrier network and an Internet service provider (not illustrated). In this example, a knowledge worker (KW) 117 is using a computing device 117 having connection to Internet backbone 101 via an Internet access line or sub-network (not illustrated). Device 117 has software (SW) 118 executable therefrom. SW 118 enables a knowledge worker or a developer to design and create controller schemes for 3D avatar-based games. Design server 108 has connection to a data repository 109 containing controller scripts that may have been designed by such as a KW operating from device 117 using SW 118. Avatar control scripts might be served to client end devices such as mobile smart phone 111 to be prioritized over default schemes in the game that may be preferential to another device or platform.

A player operating smart phone 111 may access website (WS) 104 and select an available 3D game from a list of games. A list of games may be presented as a current list of games, a recommended list of games, or a list of games returned as a result of the player entering a search term or phrase. In one implementation, smart phone 111 includes a downloaded software (SW) application 112 that may be specifically designed for the smart phone hardware and software platform. SW 112 may be a browser-based plug in application or it may be a standalone application with Internet browser components. SW 112 may be executed to connect to web site 104 and synchronize with new data such as new or revised lists of games that are currently available for play.

Smart phone 111 has a touch screen-enabled display 113. Display 113 may include a resistive touch screen or a variation thereof or a capacitive touch screen or a version thereof without departing from the spirit and scope of the present invention. A player operating smart phone 111 may be redirected to server 105 to play a game streamed by GE 107 after the player selects the game while connected to Website 104. A game session between phone 111 and server 105 is depicted herein by broken double arrow path. Smart phone 111 may be identified by WS 104 or by GE 107 relative to hardware and software platform, including display information and nature of touch screen type included with the display.

In one implementation, when a game is selected on smart phone 111 with the aid of SW 112 or on WS 104 (in the absence of SW 112), the website identifies the player's requesting device (phone 111) relative to hardware and software operating system, display type, size of display, and specific touch screen utility. This data may be forwarded to server 105 and game engine 107 during a redirect operation transparent to the player. GE 107 may have access to an avatar control script designed for mobile phone 111 platform and display type, including the type of touch screen functionality. The avatar control script may be available in data repository 106 in association with the game data for the game being played. In one implementation, the Avatar script may be available in repository 109 of design server 108. If the second scenario exists, then GE 107 may request the touch screen-based avatar script from design server 108 before the game data is streamed. In still another implementation a player operating smart phone 112 may receive an avatar control script from Web site 104 after selecting a game to play.

In one embodiment, the avatar control script is an abstract construct designed using a code such as Lua, which is a lightweight cross-platform programing language for embedded systems and clients. The avatar control script or scripts may be coded by a third party for mobile devices that may connect wirelessly to the game server. The code may be abstract in the sense that the script contains the touch screen elements and maps for enabling all input actions through the touch screen and where the touch screen may be different from another, such that only certain appropriate elements of the control may be used on a specific touch screen display. Likewise, the game avatars may vary in capabilities such as mode or method of navigation, or whether weapons can be fired or not. In another embodiment, narrow avatar controls may be provided that are specifically designed for the type touch screen and device and in-game features of the avatar.

In this example, touch screen 113 provides the entire display footprint for visualizing the game. In this case, it may be assumed that the correct avatar touch screen-based control is operating on smart phone 111. As such, the control has a capability of navigating the touch screen and dividing the screen into two or more areas or zones. In this example, touch screen 113 has two input areas created by the control scheme. An input area 115 is mapped and reserved primarily for accepting inputs for camera position and panning of the camera associated with the avatar. Area 115 may also accept other touch screen input such as a zoom feature. An input area 116 is mapped and reserved for avatar navigation within the game. The mapped areas share a border or dividing region 114 (horizontal broken line), although the dividing border may be transparent to the player. The avatar control may prepare the touch screen for avatar control during game play where the input applied through the screen by the player is disseminated at the game engine to affect the events ordered by the input in game.

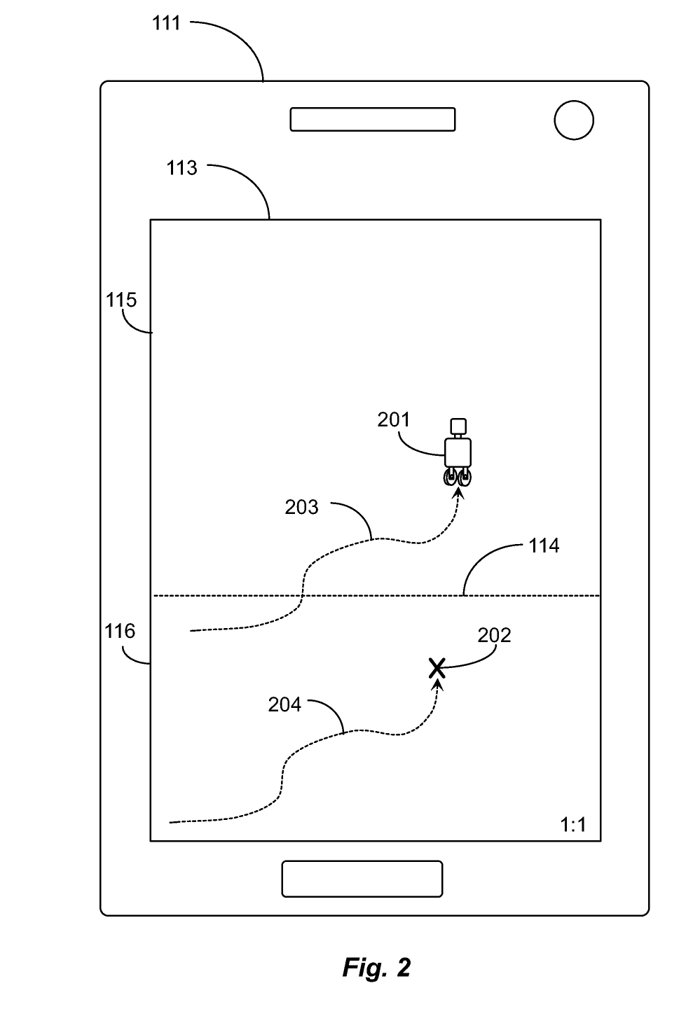

FIG. 2 is an exemplary front elevation view of a game displayed on a touch screen 113 of smart phone 111 of FIG. 1, depicting a travel control of an avatar in game. Smart phone 111 includes touch screen 113 having first control input area 115 and second control input area 116, divided by border 114. In a preferred embodiment, a player may simply touch an area on input area 116 and then drag the finger in any direction causing an in-game avatar, depicted herein as avatar 201 to move in the same direction as the drag. Input area 116 depicts a travel path 204 (broken directional arrow). Finger 202 represents the current position of the player's finger. Avatar path 203 is the same movement path as path 204 emanating from the previous position of avatar 201. The present position of avatar 201 is synonymous to the current position of finger 202 (large X).

A player may move avatar 201 by touching screen 113 in area 116 and dragging a finger to cause motion for the avatar. The nature of border region 114 allows for an overlap such that if finger 202 is drug across border 114, the movement of the avatar is still supported. An offset distance (finger position from avatar position) may be enforced so that the avatar remains visible and not obscured by the player's finger. A scale indicium 1:1 at the lower right corner in input area 116 of touch screen 113 may inform the player of scale of finger drag distance relative to avatar movement distance. In one implementation, a player may change the scale such that moving a finger a smaller distance in area 116 causes the avatar to move a proportionally greater distance. The rate of movement of the avatar is determined generally by the distance the avatar moves. Speed of finger drag may also dictate to an extent the speed of the avatar movement, such as from slow to maximum speed allowed. In this example of moving avatar 201, a player may accomplish that using only one thumb and may therefore perform these operations with one hand, the same hand holding the smart phone.

In one implementation screen 113 represents the entire graphic footprint of any 3D game displayed. In another implementation, the avatar control scheme includes the capability and instruction for assigning a portion of screen 113 to display the video game graphics. For example, the graphics may display solely in area 115 or in the entire screen. In this example about 60 percent of screen 113 defines input area 115 and 40 percent defines input area 116. However, the control scheme may include instruction for separating or dividing the screen differently such as 50/50 or 70/30 Likewise border region 114 may not be a symmetrical horizontal border it may be curved etc. without departing from the spirit and scope of the invention.

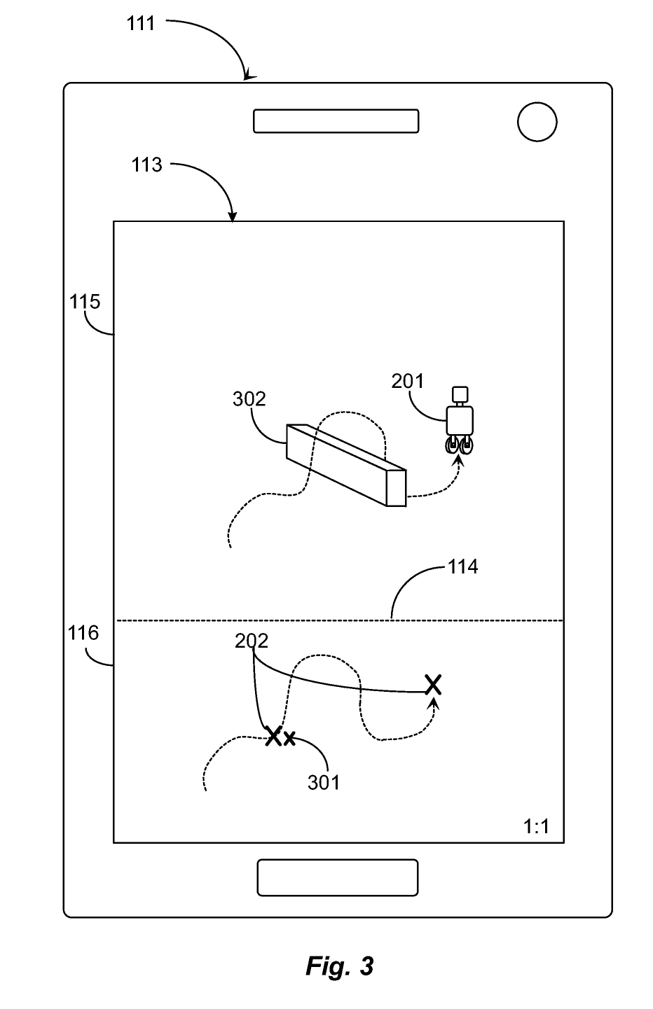

FIG. 3 is a front elevation view of smart phone 111 of FIG. 2 depicting a control for navigating an avatar over an obstacle. In this example, the avatar control includes instruction for navigating over an obstacle, in this case a wall 302. A player's thumb or finger 202 (large X) is used beginning in input area 116 of touch screen 113. The path of travel is depicted as a broken directional arrow. The actual travel path may be transparent to the player. It is depicted herein for discussion purposes only. In this example thumb or finger 202 is depicted in the travel path in input area 116 at a point along the path just before position of wall 302 (wall depicted in area 115). In one implementation, a finger tap 301 (smaller X) may be performed by the player's dragging thumb or finger or by a second finger of the player. Such a tap may be interpreted by the control script to cause avatar 201 to leap or jump over wall 302 in the way of the desired travel path.

The second depiction of the player's thumb or finger at the end of the travel path in input area 116 represents continued travel and position of avatar 201 having jumped wall 302 and continued travel. In one implementation, the camera associated with the avatar may be adapted to recognize obstacle 302 and may gauge height and forward velocity required to jump over the wall. In one implementation, this may be accomplished with an automated recognition, and avatar 201 may jump an obstacle such as wall 302 if the player continues to urge the avatar into the obstacle by finger or thumb drag, whereby no tap, such as tap 301, may be required. One with skill in the art will appreciate that for avatars having different features or modes of travel those modes are taken into consideration when navigating an obstacle. For example, an avatar that is swimming may be urged to leap out of the water and over a net to avoid capture. There are many variants that may be implemented using the same control without departing from the spirit and scope of the present invention.

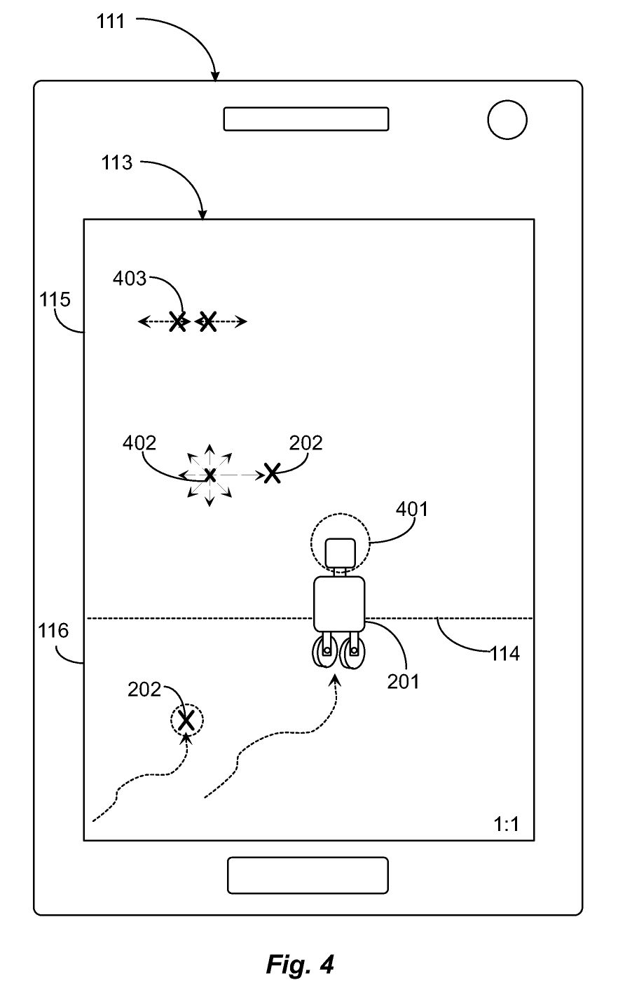

FIG. 4 is a front elevation view of smart phone 111 of FIG. 2 depicting a control among other controls for manipulating a camera associated with the avatar. Touch screen 113 depicts avatar 201 in a state of travel as urged by a player touching an area within input area 116 and dragging in a desired direction as depicted by finger or thumb 202. In this view, the original position of avatar 201 is within area 116 on touch screen 113. In one implementation, a player may, during travel, depress and hold (broken circle) the touch screen along the travel path using the same thumb or finger to cause avatar 201 to fire a weapon or to perform some other programed function such as recharging, refueling or re-arming during travel.

A touch screen avatar camera control may be included with an avatar control scheme such as a camera control 402 depicted within input area 115. A player may touch the touch screen at any point within input area 115 to reveal a camera panning and snap function that is operable with a single finger or thumb. The player may, in one implementation, touch and drag in any direction as illustrated by multiple broken directional arrows emanating from the center of the tool. Finger or thumb 202 (large X) is in a state of camera panning to the horizontal right. This unsnaps the camera position depicted herein as a camera position 401 (broken circle) from just behind the avatar and pans the camera to the right. Any direction of camera panning may be supported in the function. A thumb or finger tap (small X) may interrupt camera panning and may cause the camera to snap into position 401 behind avatar 201.

Control 402 may be statically embedded into a visible position within input area 115 of screen 113. In another implementation, the function may appear anywhere a player touches the screen with one finger or thumb. A control 403 may be provided as part of a touch screen-based avatar control scheme for zoom in and zoom out capability. In this example, a player may use a pincer movement of a finger and thumb resting upon screen 113 to zoom in by creating more distance between the thumb and finger, and to zoom out by reducing that distance. In this example, the large X represents a player's thumb and finger together. The broken horizontal directional arrows represent the direction of travel for a pincer movement performed by the player. In another implementation, a player may only use one thumb or finger 202 to zoom in and zoom out. In such a control touching and swiping a thumb to the right may cause zoom-in while touching and swiping back to the left may cause zoom-out.

Control 403 may be made visible in a static location such as an opaque or translucent visible control. In one implementation control 403 may appear when a player touches a thumb and finger in any portion of input area 115. In another embodiment, the control is not visible to the player in any form. In one implementation, a thumb or finger tap subsequent to a zoom operation may cause the display to transition to a default page size or default zoom percentage. Such a default setting might be adjustable by a player operating the control without departing from the spirit and scope of the invention. It may be assumed herein by one with skill in the art of avatar movement through device input, that other features or functions of an avatar may be provided and controlled using a finger or thumb drag and tap method. It is provided herein that multiple functions relative to avatar 201 may be controlled using only one thumb or finger of a player, enabling that player to play the game with a hand-held mobile (smart phone) using only one hand.

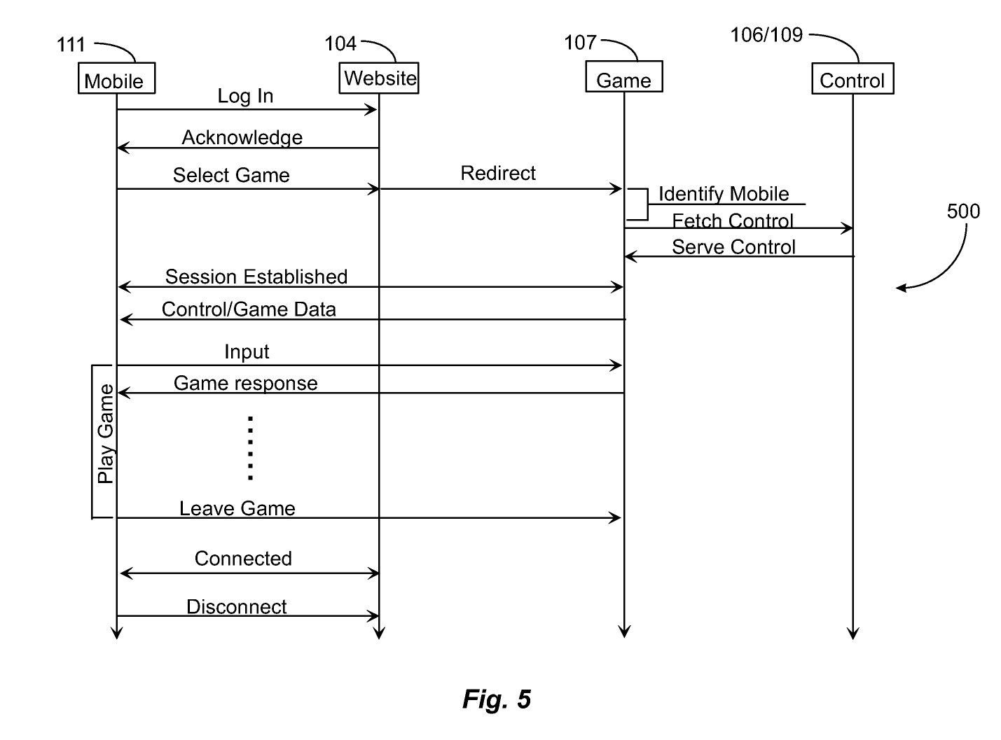

FIG. 5 is a sequence diagram depicting a sequence for identifying a smart phone, or other mobile device, requesting to play a game, and providing avatar control logic to the requesting mobile device. In this example, the diagram begins a sequence with a player's device that is represented herein by block 111, labeled mobile, in turn representing smart phone 111 of FIG. 1. A player operates smart phone 111 to log in to a gaming website represented herein by a block 104, labeled website, and analogous to WS 104 of FIG. 1. Website 104 acknowledges log in. Log in credentials, such as user name and password, may be part of the log in procedure. A player may accomplish log in and game selection by executing a local application such as application 112, in which execution thereof includes connecting automatically to the network and website.

It is presumed herein, that once a player has logged in, a list of games may be presented, such as by syncing with a web list for game selection. The player may select a game from within the local application. Website 104 may redirect the player to a game engine depicted herein as a block 107 labeled Game. Block 107 may be analogous to game engine 107 of FIG. 1. Game engine 107 has access to the game and the game may be already running, wherein the player must join the game with other players. In one implementation, game engine 107 identifies the device make and touch screen type and capabilities as illustrated by bracket and label “identify mobile”. In one implementation, this information is garnered during log in at website 104 and passed to the game server/engine during the redirect operation.

Having successfully identifying the joining player's device, the game engine may fetch an avatar control from a local or external repository or data store depicted herein as block 106/109, analogous to respective repositories of the same elements in FIG. 1, and serve the touch screen-nested avatar control to the player's device ahead of any game data. In one implementation, the control may be served after the player selects an avatar and selects avatar features or traits, if that is part of the game procedure. In this case, there may be more than one avatar control for different avatars available for selection. In this case, the control is served to the game engine before the player joins the game session. The game session may be established and the control may be served just ahead of the incoming game data. Such a control set for the avatar may automatically read the player's touch screen parameters, and may auto-configure the touch screen for input areas as described above.

The player may play the 3D game in session, depicted here as a bracket labeled “play game” that encompasses player game inputs and game responses, and ending with game departure on the part of the player labeled “leave game”. When the player leaves the game, there may still be a connection to website 104 and the player may select and launch a second game, etc. The player may eventually log off of the website or otherwise close the local application to disconnect from the website. In one implementation, the website identifies the player's device, and provides that information to the game server/engine. In one implementation, the game engine may have the correct avatar control for the touch screen in the game data which may be accessed locally.

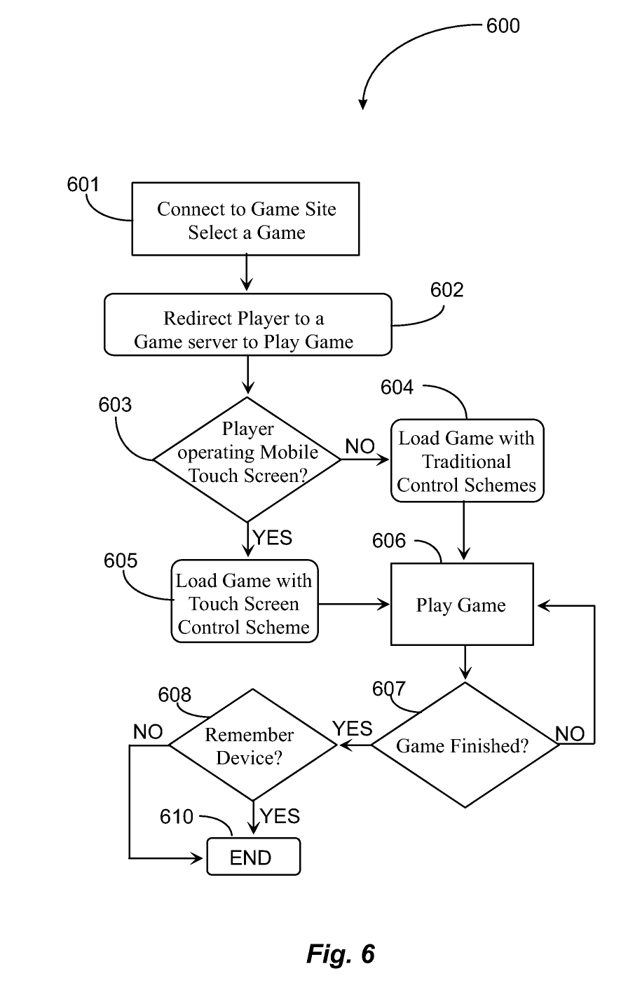

FIG. 6 is a process flow chart depicting steps for identifying a mobile device, such as a smart phone, requesting to play a game, and providing appropriate avatar control logic to the requesting smart phone for the purpose of playing the game. In step 601 a player may connect to a game site (website) and select a game. This process may involve authentication and may occur as a result of the player executing a local game application that is browser-based. After selection of the game in process 601 the website may redirect the player at step 602 to a game server and engine to play the game.

At step 603 the game engine may determine whether or not the player is operating a smart phone or other mobile device with a touch screen. If the player is not operating a mobile touch screen display in step 603, the traditional control scheme for the device the player is operating may be selected from more than one, loaded with or otherwise prioritized in the game being served. If the game engine determines that the player is operating a smart phone, or other mobile device with a touch screen of the type the available touch screen-based avatar control scheme supports at step 603, the game may be loaded with the correct touch-screen based avatar control.

It is important to note herein that a variation of the process includes identification of the player's device and touch screen before connecting the player to the game service, such as at the game site. Step 603 may also be determined by the game server or game engine without departing from the spirit and scope of the invention. In one aspect, the player is joining a game already in progress, and may receive the touch screen-based control before receiving game data. In one implementation, a player may be given a choice to accept the touch-screen avatar control over one or more controls that might use other input hardware, such as a small keypad or other smart phone controls or input buttons.

At step 606 the player may be playing the game until such time the player is finished. At step 607 the player may determine if the game is finished. In one implementation, the decision may be made by the game server or game engine. One game server may spawn multiple game engines. If at step 607 the game is not finished, the process may resolve back to step 606 for continued play. If it is determined at step 607 that the game is finished, such that the game is over, the number of players has dropped below a minimum, or the player simply leaves the game. At step 608 the player may be prompted if they desire for the game system or provider to remember that player's accessing device parameters. If at step 608 the player wishes the server or game engine to remember the device profile for future games, the service records the profile for the player. The process may then end at step 610. If the player does not wish that the device profile be recorded permanently at the game server at step 608, the data will be expunged or deleted at the server and identification may be required at the next session between the player and server. The process ends for the player at step 610.

It will be apparent to one with skill in the art that the touch screen-based avatar control system of the invention may be provided using some or all of the described features and components without departing from the spirit and scope of the invention. It will also be apparent to the skilled artisan that the embodiments described above are specific examples of a single broader invention that may have greater scope than any of the singular descriptions taught. There may be many alterations made in the descriptions without departing from the spirit and scope of the invention.

It will be apparent to the skilled person that the arrangement of elements and functionality for the invention is described in different embodiments in which each is exemplary of an implementation of the invention. These exemplary descriptions do not preclude other implementations and use cases not described in detail. The elements and functions may vary, as there are a variety of ways the hardware may be implemented and in which the software may be provided within the scope of the invention. The invention is limited only by the breadth of the claims below.

1. A game platform, comprising:
a mobile device having a touch screen, and software (SW) enabling connection to a network-connected game server; and
a control script executing on a processor of the mobile device;
wherein, in game play, the control script configures the touch screen into a first contiguous physical region wherein specific modes of touch in the first region control avatar movement, and a second contiguous physical region wherein specific modes of touch in the second region control camera position and direction in absence of visible control graphics displayed on the screen.

2. The game platform of claim 1 wherein a touch and drag in the first region causes the avatar to move in the environment of the game in the direction of the drag.

3. The game platform of claim 2 wherein rate of movement of the avatar during drag is controlled by distance of drag from an original touch point.

4. The game platform of claim 2 wherein a tap on the touch screen causes the avatar to jump in the environment.

5. The game platform of claim 4 wherein the tap on the touchscreen causes the avatar to jump onto or over a landscape element in the environment.

6. The game platform of claim 4 wherein avatar position relative to landscape elements is used by the control script to determine avatar action relative to the landscape elements.

7. The game platform of claim 1 wherein a touch and drag in the second region causes camera direction to change in the display on the touch screen.

8. The game platform of claim 7 wherein a drag vector up or down causes the camera to pan up or down, and a drag vector to left or right causes the camera to pan left or right.

9. The game platform of claim 1 wherein a pinch-to-zoom action in the second contiguous physical region controls zoom in and zoom out for the camera.

10. The game platform of claim 1 wherein the mobile device is a smart telephone.

11. The game platform of claim 1 wherein, prior to connection to the network-connected game server, and streaming of a game to the mobile, device control and touchscreen parameters of the mobile platform are determined, and a compatible control script is served to the mobile device.

12. A method, comprising:
executing a control script on a processor of a mobile device having a touch screen, and software (SW) enabling connection to a network-connected game server;
displaying a game on the touchscreen; and
configuring the touch screen, by execution of the control script on the processor, into a first contiguous physical region wherein specific modes of touch applied anywhere in the first region control avatar movement in the game, and a second contiguous physical region wherein specific modes of touch applied anywhere in the second region control camera position and direction in absence of visible control graphics displayed on the screen.

13. The method of claim 12 wherein a touch and drag in the first region causes the avatar to move in the environment of the game in the direction of the drag.

14. The method of claim 13 wherein rate of movement of the avatar during drag is controlled by distance of drag from an original touch point.

15. The method of claim 13 wherein a tap on the touch screen causes the avatar to jump in the environment.

16. The method of claim 15 wherein the tap on the touchscreen causes the avatar to jump onto or over a landscape element in the environment.

17. The method of claim 15 wherein avatar position relative to landscape elements is used by the control script to determine avatar action relative to the landscape elements.

18. The method of claim 12 wherein a touch and drag in the second region causes camera direction to change in the display of the environment on the touch screen.

19. The method of claim 18 wherein a drag vector up or down causes the camera to pan up or down, and a drag vector to left or right causes the camera to pan left or right.

20. The method of claim 12 wherein a pinch-to-zoom action in the second contiguous physical region controls zoom in and zoom out for the camera.

21. The method of claim 12 wherein the mobile device is a smart telephone.

22. The method of claim 12 wherein, prior to connection to the network-connected game server, and streaming of a game to the mobile device, control and touchscreen parameters of the mobile platform are determined, and a compatible control script is served to the mobile device.

23-24. (canceled)
